(19) United States
(12) Patent Application Publication
(10) Pub. No.: US 2026/0330820 A1
(43) Pub. Date: Oct. 22, 2026

(54) METHOD AND DEVICE FOR AUTOMATICALLY CALCULATING WINDOW SET INFORMATION USING ARTIFICIAL NEURAL NETWORK

(71) Applicant: IUCF-HYU (INDUSTRY-UNIVERSITY COOPERATION FOUNDATION HANYANG UNIVERSITY), Seoul (KR)

(72) Inventors: Hak Sung KIM, Seoul (KR); Sang Il KIM, Seoul (KR); Se Min LEE, Seoul (KR); Gyu Won KIM, Seoul (KR); Young Gu HAN, Seoul (KR)

(73) Assignee: IUCF-HYU (INDUSTRY-UNIVERSITY COOPERATION FOUNDATION HANYANG UNIVERSITY), Seoul (KR)

(21) Appl. No.: 19/112,346

(22) PCT Filed: Sep. 13, 2023
(86) PCT No.: PCT/KR2023/013760

§ 371 Date: Mar. 17, 2025

(30) Foreign Application Priority Data
Sep. 15, 2022 (KR) 10-2022-0116577

(51) Int. Cl. G06V 10/82; G06V 10/42

(52) U.S. Cl. CPC G06V 10/82; G06V 10/42

(57) ABSTRACT

A device for automatically calculating window set information using artificial neural networks according to an embodiment comprises a pre-trained artificial neural network module calculating window set information having a first input information comprising image information as input information, and a window set information extracting window set characteristics from the image information as output information and a feature extractor for extracting a 1-1 feature map and a 1-2 feature map having different scale values for the image information, in the artificial neural network module calculating window set information, wherein the artificial neural network module calculating window set information is generating a 3-1 feature map and a 3-2 feature map by applying convolution to the 1-1 feature map and the 1-2 feature map, respectively, and then determining one of the 3-1 feature map and the 3-2 feature map as a final feature map based on a preset criteria, and then calculating the window set information based on the selected final feature map.

### TECHNICAL FIELD

The present invention relates to a method and device for automatically calculating window set information using an artificial neural network, and more specifically, to a technique for classifying a window set region in an input image using a pre-trained artificial neural network and automatically calculating window set information for the classified window set region.

### BACKGROUND ART

In a building, the indoor space is a space that maintains the comfort of occupants from changes in the indoor and outdoor environment in terms of built environment facilities. Occupant comfort can change in real time due to a combination of several thermal factors, the most representative of which is temperature. Therefore, it is necessary to evaluate the temperature distribution to create a comfortable indoor environment for occupants.

On the other hand, in recent years, due to environmental issues such as global warming, technologies for efficiently managing and reducing thermal energy in industrial and domestic buildings have been attracting attention, and various remodeling projects have been carried out to manage and reduce daylight energy in industrial and public buildings.

For retrofitting to manage and reduce daylight energy, the building's light energy characteristics should be analyzed using the existing building plans to design the building. In such a design, various factors affecting the building's light energy characteristics must be considered, and among the factors that affect the building most closely is the window set, which has the greatest impact on the amount of light energy entering the building, including the amount of solar gain and daylight area.

Designing a window set for a building usually requires geometric information about the existing building window set, as detailed geometric dimensions of the window set are required to calculate the light properties of the window set, such as solar gain and daylight area. However, in older buildings, the drawings may have been lost over time and the window set geometry information may not be available. In this case, the builder or designer must manually measure the geometry of the window set shape of the existing building, which can be costly and time-consuming. This is also a limitation of analyzing window set optical properties using the geometry information of existing building window set shape.

### DISCLOSURE

### Technical Problem

Accordingly, a method and device for automatically calculating window set information using an artificial neural network, according to one embodiment, is an invention designed to solve the problems described above, with an objective to provide a method for automatically calculating window set information that can automatically classify a window set region for an input image and automatically calculate window set information for the classified region.

It also aims to provide a more efficient way to manage buildings by calculating information about the solar gain and daylight area, which affect the building's light characteristics, based on the calculated window set information.

The effects of the present invention are not limited to the technical challenges described above, and other effects not mentioned will be apparent to those skilled in the art from the following description.

### Technical Solution

A device for automatically calculating window set information using artificial neural networks according to an embodiment comprises a pre-trained artificial neural network module calculating window set information having a first input information comprising image information as input information, and a window set information extracting window set characteristics from the image information as output information and a feature extractor for extracting a 1-1 feature map and a 1-2 feature map having different scale values for the image information, in the artificial neural network module calculating window set information, wherein the artificial neural network module calculating window set information is generating a 3-1 feature map and a 3-2 feature map by applying convolution to the 1-1 feature map and the 1-2 feature map, respectively, and then determining one of the 3-1 feature map and the 3-2 feature map as a final feature map based on a preset criteria, and then calculating the window set information based on the selected final feature map.

The artificial neural network module calculating window set information is calculating confidence information for the 3-1 feature map and the 3-2 feature map and then determining the feature map having a higher confidence value as the final feature map according to the preset criteria.

The artificial neural network module calculating window set information includes a first pre-trained artificial neural network that takes the first input information as input information and outputs the 1-1 feature map corresponding to the image information as output information.

The feature extractor above is extracting the 1-2 feature map having a different scale value with the scale value of the 1-1 feature map from the first pre-trained artificial neural network.

The artificial neural network module calculating window set information includes a second pre-trained artificial neural network that takes the 1-1 feature map as input information and the 1-2 feature map as intermediate input information, and outputs a 2-1 feature map corresponding to the 1-1 feature map and a 2-2 feature map corresponding to the 1-2 feature map as output information.

The artificial neural network module calculating window set information includes a third pre-trained artificial neural network that takes the 2-1 feature map and the 2-2 feature map as input information and outputs a 3-2 feature map corresponding to the 2-2 feature map and a 3-1 feature map corresponding to the 2-1 feature map as output information.

The artificial neural network module calculating window set information further includes an FC-layer determining one of the 3-1 feature map and the 3-2 feature map as the final feature map based on preset criteria.

The device for automatically calculating window set information using artificial neural networks further comprises an optical property information calculator calculating window set information including area information and length information of windows corresponding to the image information and area information and length information of frame based on the final feature map.

The optical property information calculator calculates solar gain and daylight area based on the window set information.

The feature extractor extracts a 1-3 feature map having different scale values with the 1-1 feature map and the 1-2 feature map about said image information from the artificial neural network module calculating window set information.

The artificial neural network module calculating window set information is calculating confidence information for the 3-1 feature map and the 3-2 feature map and then determining the feature map having a higher confidence value as the final feature map based on the preset criteria.

A method for automatically calculating window set information using artificial neural networks according to an embodiment comprises a first feature map generating step of taking a first input information including image information as input information and outputting a 1-1 feature map corresponding to the image information as output information using a pre-trained first artificial neural network, a feature extracting step of extracting a 1-1 feature map and a 1-2 feature map having different scale values for the image information by the first artificial neural network, a third feature map generating step of generating a 3-1 feature map and a 3-2 feature map by applying convolution respectively to the 1-1 feature map and the 1-2 feature map and a window set information calculating step of determining one of the 3-1 feature map and the 3-2 feature map as a final feature map based on a preset criteria and then calculating window set information based on the selected final feature map.

The method for automatically calculating window set information using artificial neural networks according to an embodiment further comprises a window set information calculating step of calculating window set information including area information and length information of windows corresponding to the image information and area information and length information of frame based on the final feature map.

A device for automatically calculating window set information using artificial neural networks according to an embodiment comprises a pre-trained artificial neural network module calculating window set information having a first input information comprising image information as input information, and a window set information extracting window set characteristics from the image information as output information and a feature extractor for extracting a 1-1 feature map and a 1-2 feature map having different scale values for the image information, in the artificial neural network module calculating window set information, wherein the artificial neural network module calculating window set information is generating a 3-1 feature map and a 3-2 feature map by applying convolution to the 1-1 feature map and the 1-2 feature map, respectively, and then determining one of the 3-1 feature map and the 3-2 feature map as a final feature map based on a preset criteria, and then calculating the window set information based on the selected final feature map, and wherein the artificial neural network module calculating window set information is performing training using a labeling information labeled for the window set information included in the image information.

The artificial neural network module calculating window set information is performing training by using a second input information including the labeling information and the first input information together as input information.

### Advantageous Effects

The method and device for automatically calculating window set information using an artificial neural network according to one embodiment can extract window set shape information of a building in a quick time from a photo image by labeling the shape of a window in a window set image of a building and learning it with an algorithm of an artificial neural network module, and has the advantage of detecting the shape information of a window set and extracting the window set information even when an untrained window set image is input.

Furthermore, the method and device for automatically calculating window set information using an artificial neural network according to one embodiment may be able to auto-label new images and automatically undergo further training to continuously improve accuracy.

Furthermore, the method and device for automatically calculating window set information using an artificial neural network according to one embodiment has the advantage of facilitating deriving information about optical characteristics of the window set, such as solar gain and daylight area of the window set, using the extracted window set information.

The effects of the present invention are not limited to the technical challenges described above, and other effects not mentioned will be apparent to those skilled in the art from the following description.

### DESCRIPTION OF DRAWINGS

For a more complete understanding of the drawings cited in the detailed description of the present invention, a brief description of each drawing is provided.

FIG. 1 is a diagram illustrating some components of a method and device for automatically calculating window set information using an artificial neural network, according to one embodiment of the present invention.

FIG. 2 is a diagram illustrating the components of a window set subject to measurement in the present invention.

FIG. 3 is a diagram illustrating input information and output information when artificial neural network module calculating window set information is inferring according to one embodiment of the present invention.

FIG. 4 is a diagram illustrating input and output information when artificial neural network module calculating window set information is training, according to one embodiment of the present invention.

FIG. 5 is a diagram specifically illustrating the configuration of artificial neural network module calculating window set information according to one embodiment of the present invention.

FIG. 6 is a diagram illustrating a process of artificial neural network module calculating window set information according to one embodiment of the present invention.

FIG. 7 is a diagram specifically illustrating the process of artificial neural network module calculating window set information, according to one embodiment of the present invention.

FIG. 8 is a diagram to illustrate the process of a first artificial neural network according to one embodiment of the present invention.

FIG. 9 is a diagram to illustrate the process of a second artificial neural network according to one embodiment of the present invention.

FIG. 10 is a diagram illustrating the final output information of artificial neural network module calculating window set information according to one embodiment of the present invention.

FIG. 11 is a diagram to illustrate a training method for artificial neural network module calculating window set information, in accordance with one embodiment of the present invention.

FIG. 12 is a diagram illustrating a method for labeling training data, according to one embodiment of the present invention.

FIG. 13 is a diagram illustrating a method for calculating solar heat gain by window set information calculation device, in accordance with one embodiment of the present invention.

FIG. 14 is a graph showing the solar gain by month/year for a window set calculated according to the method shown in FIG. 13.

FIG. 15 is a diagram illustrating a method calculating daylight area by window set information calculation device, according to one embodiment of the present invention.

FIG. 16 is a diagram comparing the value for the daylight area derived by window set information calculator according to one embodiment of the present invention with the value derived by the finite element analysis results.

### MODES OF THE INVENTION

Hereinafter, embodiments according to the invention will be described with reference to the accompanying drawings. It should be noted that in assigning reference numerals to the components in each drawing, the same components have been given the same numeral designation to the extent possible, even if they are shown in different drawings. Further, in describing embodiments of the present invention, specific descriptions of related disclosed configurations or features are omitted where it is determined that such detailed description would impede an understanding of the embodiments of the present invention. Further, while embodiments of the invention will be described below, the technical ideas of the invention are not limited or restricted and may be practiced in various modifications by those skilled in the art.

Further, the terms used herein are for the purpose of describing embodiments and are not intended to limit and/or define the disclosed invention. Expressions in the singular include the plural unless the context clearly indicates otherwise.

As used herein, the terms “including”, “comprising”, or “having” are intended to designate the presence of the features, numbers, steps, operations, components, parts, or combinations thereof described herein, and do not preclude the presence or addition of one or more other features, numbers, steps, operations, components, parts, or combinations thereof.

In addition, throughout the specification, when a part is said to be “connected” to another part, this includes not only when it is “directly connected” but also when it is “indirectly connected” with another element in between, and ordinal numeral terms such as “first,” “second,” and the like as used herein may be used to describe various components, but such components are not limited by such terms.

Embodiments of the present invention will be described below with reference to the accompanying drawings in such detail as to facilitate practice by one having ordinary skill in the art to which the invention belongs. To clearly illustrate the invention in the drawings, parts not pertinent to the description are omitted.

The name of the invention is “method and device for automatically calculating window set information using an artificial neural network,” but in the following description, for convenience of explanation, the “device for automatically calculating window set information using an artificial neural network” is referred to as the “window set information calculation device,” and the “method for automatically calculating window set information using an artificial neural network” is referred to as the “window set information calculation method.

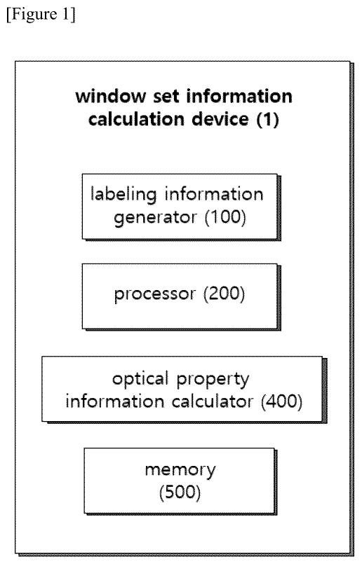

FIG. 1 is a diagram illustrating some components of a method and device for automatically calculating window set information using an artificial neural network, according to one embodiment of the present invention.

Referring to FIG. 1, a window set information calculation device 1 using an artificial neural network according to one embodiment may include a labeling information generator 100, a processor 200, an optical property information calculator 400, and a memory 500. The components of the window set information calculation device 1 according to the present invention are not limited to those configured in FIG. 1, and may include fewer components than those shown, or may be implemented by combining additional components.

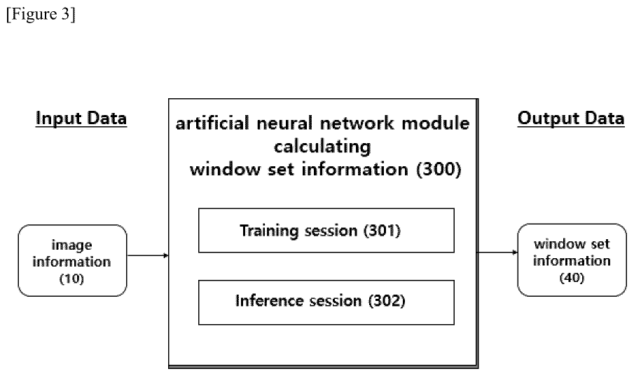

The labeling information generator 100 refers to a generator that generates data necessary for the artificial neural network module calculating window set information 300 (see FIG. 3) to perform training according to the present invention.

The labeling information generator 100 is a component that generates data for the window set information calculating artificial neural network module 300 to learn or make inferences. The data generated by the labeling information generator 100 includes specific numerical information and area information about the window sets corresponding to the images input to the artificial neural network module calculating window set information 300. This can serve as training data for the artificial neural network module calculating window set information 300 to perform training.

The labeling data generated by the labeling information generator 100 may be input to the window set information calculation device 1 along with the image information 10 as input information or may be utilized as reference information corresponding to the inferred information subsequently output. A specific description of this will be described later.

The processor 200 may serve to control the overall operation of the window set information calculation device 1 according to the present invention. The processor 200 includes an artificial neural network module calculating window set information 300 and may calculate region information numerical information regarding window sets from an image input to the processor 200. The specific process of the artificial neural network module calculating window set information 300 will be described in more detail with reference to FIG. 3 to FIG. 9.

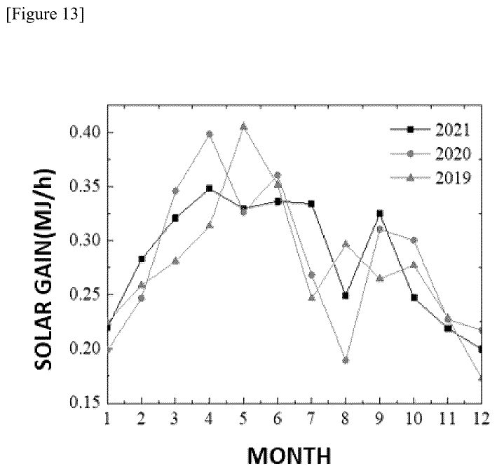

Based on the area information and numerical information about the window set calculated by the processor 200, the optical property information calculator 400 may calculate an amount of solar heat gain and a daylight area corresponding to the light characteristic value of the window set entering the building interior. This will be described in more detail with reference to FIG. 13 to FIG. 16.

The memory 500 may store the input image information 10, the labeling data generated by the labeling information generator 100, the window set information generated by the processor 200, and the optical property information generated by the optical property information generator 400, and various other information about the building to be analyzed.

While FIG. 1 illustrates the memory 500 as a separate component from the processor 200, embodiments of the present disclosure are not limited thereto, and the present disclosure may be implemented in which the memory 500 is combined with the processor 200 as a single component.

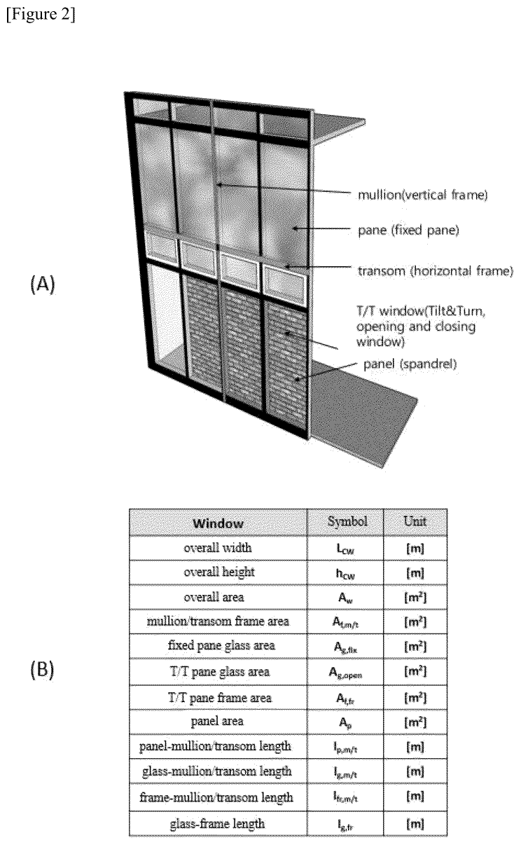

FIG. 2 is a diagram illustrating the components of a window set subject to measurement in the present invention.

A window set in a building contains many different components, including panes, frames, and panels, and to accurately calculate window set information, it needs to know where these components are located, the area they occupy, and their length.

Specifically, a window set may include a mullion corresponding to a vertical frame, a pane corresponding to a fixed pane, a transom corresponding to a horizontal frame, a T/T window corresponding to the opening and closing window, a panel corresponding to a spandrel, and the like, the area and dimensions of which may be variously defined, as shown in (A) of FIG. 2.

Specifically, the window set information may include information about the window set's overall width, overall height, overall area, mullion/transom frame area, fixed pane glass area, T/T pane glass area, T/T pane frame area, panel area, panel-mullion/transom length, glass-mullion/transom length, frame-mullion/transom length, glass-frame length, and the like, as shown in (B) of FIG. 2.

The window set information calculation device 1 according to the present invention has the purpose of automatically calculating, when an image is input as input information as shown in (A) of FIG. 2, compartmentalized information of components in the image and numerical information of each component as shown in (B) of FIG. 2. The following drawings will now be described in detail to illustrate the specific process of the present invention.

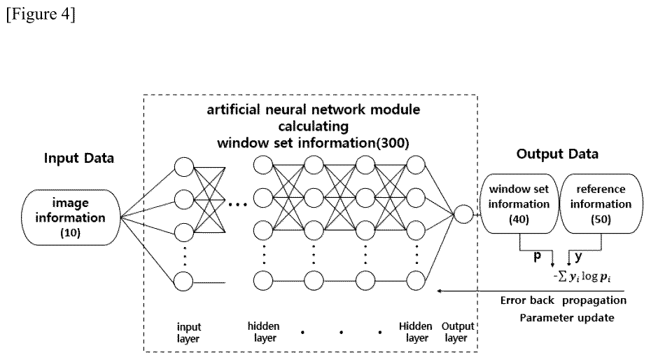

FIG. 3 is a diagram illustrating input information and output information when artificial neural network module calculating window set information is inferring according to one embodiment of the present invention, and FIG. 4 is a diagram illustrating input and output information when artificial neural network module calculating window set information is training, according to one embodiment of the present invention.

Referring to FIGS. 3 and 4, the artificial neural network module calculating window set information 300 according to the present invention means a pre-trained artificial neural network that has a first input information including image information 10 as input information and output information including window set information 40 that extracts area information and numerical information about the window set from the input image information 10 as output information.

An artificial neural network module calculating window set information 300 according to the present invention may include a learning session to perform training based on first input information 10 comprising image information, output information 40 comprising window set information, and reference information (ground truth) 50 corresponding to the output information 40, and an inference session to infer first output information 40 based on the first input information 10 as shown in FIG. 4. Although the figures show the learning session and the inference session separately, embodiments of the present invention are not limited thereto and the learning session and the inference session may be implemented separately.

In the case of the present invention, when the artificial neural network module calculating window set information 300 performs learning, learning may be performed based on the first output information 40 and the reference information 50 as illustrated in the figure, but learning may also be performed by inputting numerical information corresponding to the image information to the artificial neural network module calculating window set information 300.

Specifically, the input information input to the artificial neural network module calculating window set information 300 includes a first input information 10 that includes image information and a second input information 20 that is labeled with numerical information about the window set included in the image information, so that the artificial neural network module calculating window set information 300 can perform training based on the two input information.

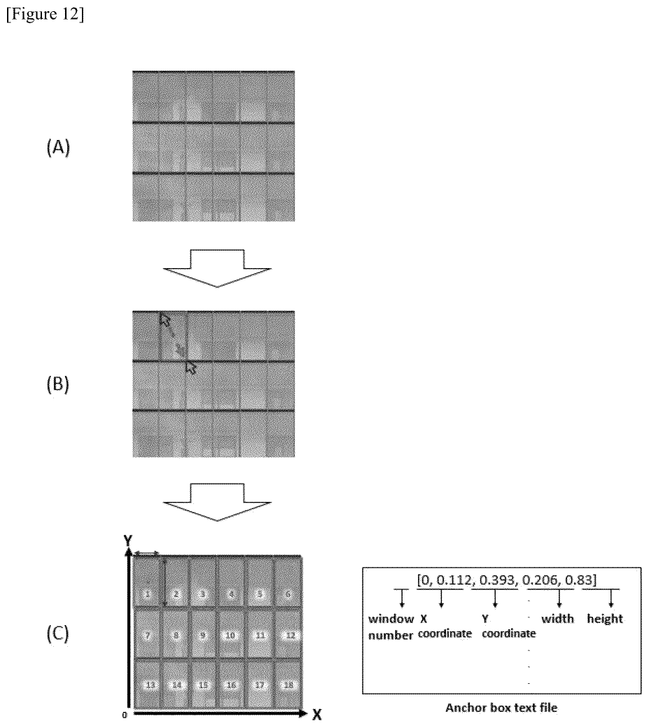

On the other hand, in the present invention, performing learning means adjusting the parameters of the artificial neural network, and the second input information 20 input to the artificial neural network module calculating window set information 300 may mean labeling information corresponding to the image information generated by the labeling information generator 100. This will be described later with reference to FIG. 12.

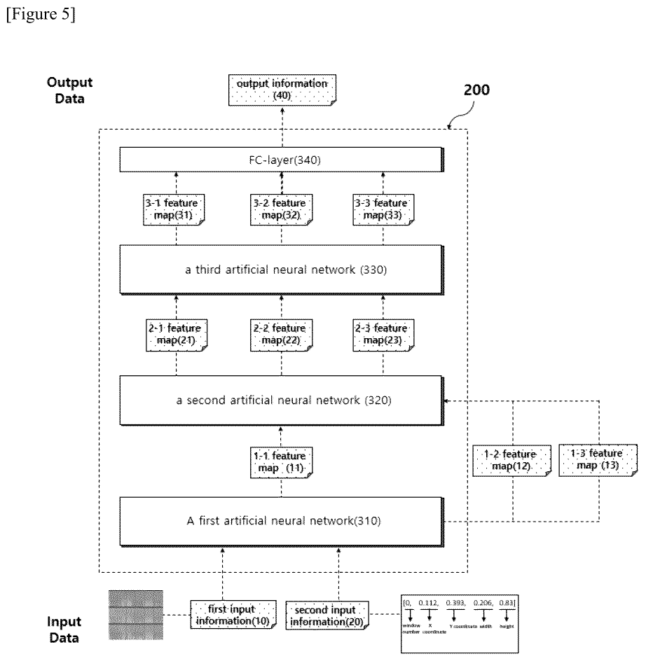

FIGS. 5 through 9 are drawings to illustrate how the artificial neural network module calculating window set information 300 learns, with FIG. 5 is a diagram specifically illustrating the configuration of artificial neural network module calculating window set information according to one embodiment of the present invention.

Referring to FIG. 5, an artificial neural network module calculating window set information 300 according to the present disclosure may include a first artificial neural network 310, a second artificial neural network 320, a third artificial neural network 330, and an FC-layer 340.

While FIG. 5 illustrates the artificial neural network module calculating window set information 300 as having three artificial neural networks and one FC-layer, this is for illustrative purposes only and does not limit the embodiments of the present invention. Accordingly, all three artificial neural networks may be combined into a single artificial neural network, or all three artificial neural networks and one FC-layer may be combined into a single artificial neural network.

The first artificial neural network 310 refers to a pre-trained artificial neural network that takes a first input information 10 comprising image information and a second input information 20 comprising at least one of numerical information and area information for a window set included in the image information as input information and applies a convolution to the image information to output a 1-1 feature map 11 as output information.

In the case of the first artificial neural network 310, since the convolutional operation is performed over a plurality of times, the feature map generated internally in the first artificial neural network 310 may be a plurality of feature maps having different scales.

Accordingly, the feature map extractor (not shown) may extract the 1-2 feature map 12 and the 1-3 feature map 13 from the first artificial neural network 310 and output them as intermediate output information of the first artificial neural network 310 as shown in the figure, and the output intermediate output information may be input as intermediate input information of the second artificial neural network 320 in parallel.

On the other hand, in FIG. 5, the intermediate output information output by the first artificial neural network 310 is shown as two feature maps (1-2 feature map, 1-3 feature map), but the embodiment of the present invention is not limited to this. As described above, the feature maps corresponded to the intermediate output information output by the first artificial neural network 310 mean feature maps having a different scale value with the scale value of the 1-1 feature map 11, so the number of feature maps corresponding to the intermediate output information can be freely varied according to the purpose of the present invention.

In one example, feature maps having a scale value different from the scale value of the 1-1 feature map 11 may be implemented as two, four, or five feature maps, in which case each feature map may have a different scale value. For ease of explanation, only two feature maps that are intermediate output information of the first artificial neural network 310 will be described herein, the 1-1 feature map 11 and the 1-2 feature map 12.

The second artificial neural network 320 performs a convolution operation based on the 1-1 feature map 11 output by the first artificial neural network 310 and the 1-2 feature map 12 and the 1-3 feature map 13, which are intermediate output information of the first artificial neural network 310 and outputs a 2-1 feature map 21 that enhances the features of the 1-1 feature map 11, a 2-2 feature map 22 that enhances the features of the 1-2 feature map 12, and a 2-3 feature map 23 that enhances the features of the 1-3 feature map 13 as output information.

As previously described, if the first artificial neural network 310 has one intermediate output information, the second artificial neural network 320 may output a total of two outputs (a 2-1 feature map and a 2-2 feature map), and if the first artificial neural network 310 has three intermediate outputs, the second artificial neural network 320 may output a total of four outputs.

The third artificial neural network 330 may take the 2-1 feature map 21, the 2-2 feature map 22, and the 2-3 feature map 23 output by the second artificial neural network 320 as input information, and independently perform a convolution operation on each of the input feature maps to output a 3-1 feature map 31, a 3-2 feature map 32, and a 3-3 feature map 33 containing the anchor box image as output information.

The FC-layer 340 (Fully connected Layer) may play a role in analyzing the 3-1 feature map 31, the 3-2 feature map 32, and the 3-3 feature map 33 output by the third artificial neural network 330, respectively, and outputting the preset criteria (the map with the most reliable information) as a final output information.

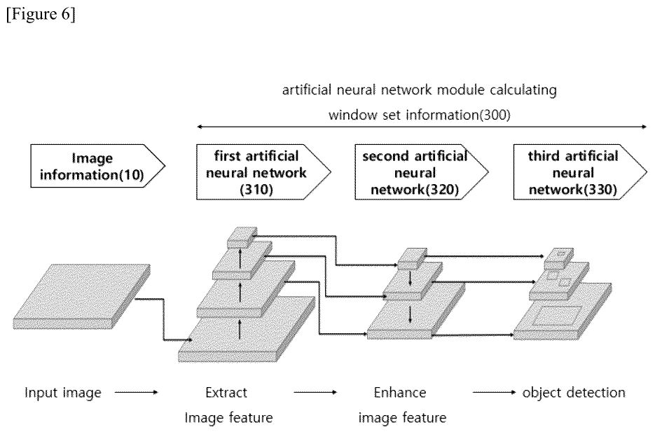

FIG. 6 is a diagram illustrating a process of an artificial neural network module calculating window set information according to one embodiment of the present invention.

Since the purpose of the artificial neural network module calculating window set information 300 according to the present invention is to extract area information about the window set from the input image information 10 and to calculate numerical information from the extracted area information, a plurality of artificial neural networks is used to calculate the window set information to achieve this purpose.

Accordingly, the artificial neural network module calculating window set information 300 may extract a first feature map that extracts image features for the input image information 10 using the first artificial neural network 310, a second feature map through a process of enhancing the features of the image for the extracted first feature map, and a third feature map through a process that may extract final object detection information for the extracted second feature map as shown in FIG. 6. The following drawings illustrate the processes of each of the artificial neural networks in detail.

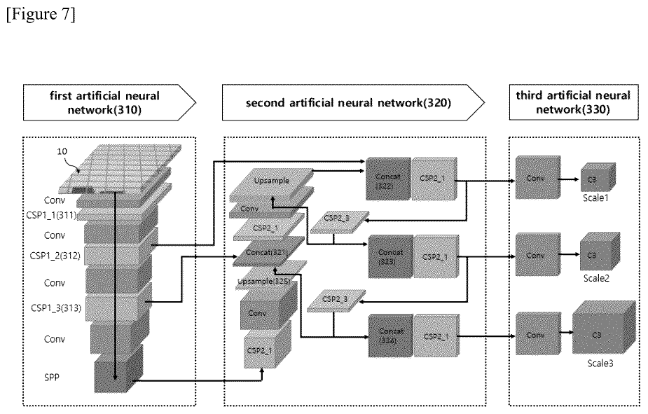

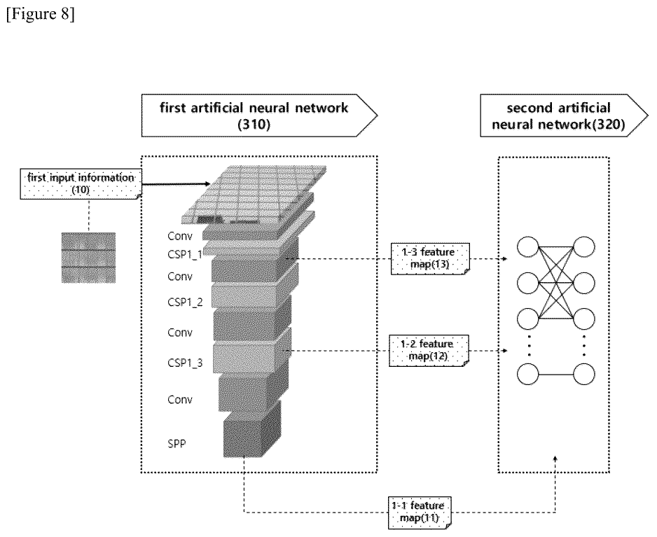

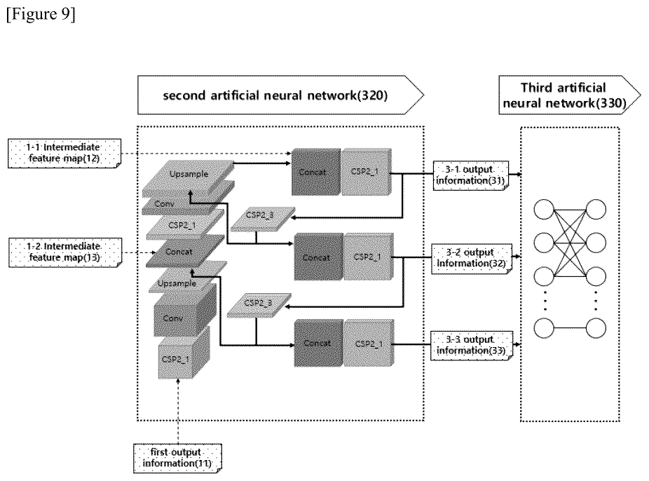

FIG. 7 is a diagram specifically illustrating the process of artificial neural network module calculating window set information, according to one embodiment of the present invention. FIG. 8 is a diagram to illustrate the process of a first artificial neural network according to one embodiment of the present invention. FIG. 9 is a diagram to illustrate the process of a second artificial neural network according to one embodiment of the present invention.

Referring to FIGS. 7 and 8, the first artificial neural network 310 is an artificial neural network extracting feature for the input image information 10 and may extract a first feature map 11 by applying convolutional-based network.

Specifically, the first artificial neural network 310 may utilize a convolutional-based BottleNeck-CSP (Cross Stage Network) network to convert incoming image information from a three-dimensional form of data to a one-dimensional form of data.

The first process of the first artificial neural network 310 is the focusing step, which is a process that unifies the multiple images into a consistent format (e.g., 3×1024×1024) to simplify model computation. This has the advantage of accelerating the effectiveness of the training.

At the end of the focusing step, the first artificial neural network 310 extracts features from the input image information by iterating through the convolutional layer and the BottleneckCSP multiple times. The BottleneckCSP compresses the channels of the input values to extract features and then increases the channels again.

The 256 channels are reduced to 64 channels by Conv 1×1, which reduces the amount of computation.

Since spatial feature extraction is not possible in Conv 1×1, extracting features in Conv 3×3. Afterward, the parameters are reduced to Conv 1×1 while expanding the channels back to 256. As the first artificial neural network 310 performs training, the number of channels is increased with Conv 1×1 because the more features in the feature map, the better the learning.

After the convolutional layer in the first artificial neural network 310, the convolutional layer goes through a batch normalization process and proceeds to the BottleneckCSP. In this step, the first convolutional layer 310 is implemented to create four convolutional layers, two of which are short connected to each other to derive the computed values, and the computed values from the other convolutional layers are combined and passed through the remaining one convolutional layer. Then, batch normalization was applied to the first and fourth layers only.

As a final step of the first artificial neural network 310, a spatial pyramid pooling layer (SPP) process is performed to arrange the extracted feature maps in a fixed one-dimensional form, and then the feature maps with the SPP process can be input as input information to the fully connected layer (FC-layer), so that the final output information of the first artificial neural network 310 is the 1-1 feature map 11.

As illustrated, the first artificial neural network 310 may output a 1-2 feature map 12 and a 1-3 feature map 13 as intermediate output information, wherein the 1-2 feature map 12 and the 1-3 feature map 13 are feature maps having different scale values from the 1-1 feature map 11.

In other words, since the input image information 10 is organized in layers such that the number of channels increases as it passes through the first artificial neural network 310 step by step, the scale of the feature map changes as it passes through the layers. Thus, the 1-3 feature map 13 becomes a feature map with a smaller number of channels than the 1-2 feature map 12, the 1-2 feature map 12 becomes a feature map with a smaller number of channels than the 1-1 feature map 11, and so on, the feature maps extracted in the intermediate process of the first artificial neural network 310 are input as intermediate input values to the second artificial neural network 320.

The second artificial neural network 320 is an artificial neural network that consists of a path-aggregation network (PANet) stage that refines features for the feature map that has been through the first artificial neural network 310 and aims to enhance information flow.

Specifically, the second artificial neural network 320 is an artificial neural network that collects and processes feature maps of various sizes (having various scale values) through the first artificial neural network 310, and is characterized in that it improves the accuracy of localization by strengthening the entire feature layer by bottom-up path augmentation to solve a problem that may occur because the low-level feature maps obtained in the previous step are not well input to the convolutional layer in the later step.

So, the second artificial neural network 320 is with one shortcut from the bottom layer to the top layer and a convolutional layer, the flow is smoother than the traditional backbone model.

The Concat layer 321 of the second artificial neural network 320 serves to combine the immediately preceding layer in the second artificial neural network 320, the Upsampling layer 325, with the third CSP layer 313 of the first artificial neural network 310.

Specifically, the second artificial neural network 320 uses a total of four Concat layers 321,322,323,324, wherein the first Concat layer is connected to the third CSP layer 313 of the first artificial neural network 310, the second Concat layer 322 combines the third CSP layer 313 of the first artificial neural network 310 with the Upsampling layer to detect small-scale objects, and the remaining two concat layers 323, 324 combine the CSP and Conv layers of the second artificial neural network 320 to detect medium-scale and large-scale objects.

Accordingly, the 2-1 feature map 21 passed through the second concat layer 322, the 2-2 feature map 22 passed through the third concat layer 323, and the 2-3 feature map 23 passed through the fourth concat layer 324 are output as feature maps having different scales (the scale of the 2-3 feature map is the largest, the scale of the 2-2 feature map is medium, and the scale of the 2-1 feature map is the smallest) feature maps are output, and these output feature maps are respectively input as input information to the third artificial neural network 330.

The third artificial neural network 330 performs convolution on the scales of the three input images and finally derives the results as the 3-1 feature map 31, 3-2 feature map 32, and 3-3 feature map 33, respectively. The resulting multiscale feature maps can be used to quickly generate anchor boxes with fast inference speed.

The three feature maps output from the third artificial neural network 330 are finally input to the FC-layer 340, which outputs the window set information (area information and numerical information) calculated based on the most reliable feature map among the three feature maps as the final output information of the artificial neural network module calculating window set information 300.

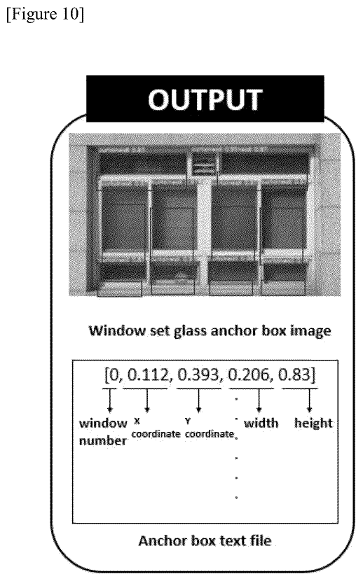

FIG. 10 is a diagram illustrating the final output information of artificial neural network module calculating window set information according to one embodiment of the present invention.

Referring to FIG. 10, the final output information can be output as an anchor box image with the window set segmented into regions, and the image is derived by accurately anchor boxing only the part of the image corresponding to the glass. The obstacles blocking the front of the window set and reflections on the window are also reflected in the deep learning training, resulting in good discrimination results.

In addition, the final information may include information about the window number and the corresponding X coordinate, Y coordinate, width, height, etc. as shown in the drawing, which may be output together as text file information.

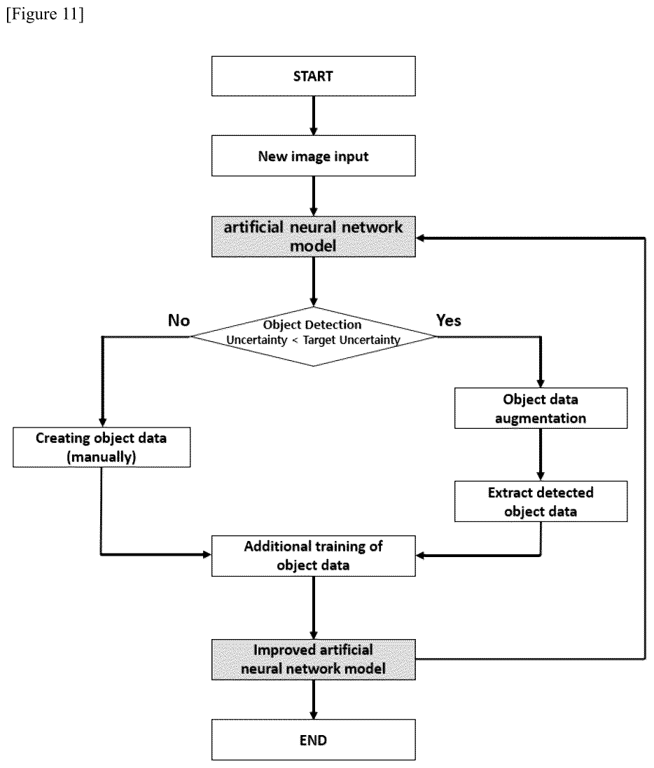

FIG. 11 is a diagram to illustrate a training method for artificial neural network module calculating window set information, in accordance with one embodiment of the present invention and FIG. 12 is a diagram illustrating a method for labeling training data, according to one embodiment of the present invention.

Referring to FIGS. 11 and 12, the artificial neural network module calculating window set information 300 according to the present invention receives a new image as input data, and performs object detection on the input image, and if the uncertainty result of the object detection is lower than the target uncertainty, the object data is manually created for further training.

The method of manually generating training data includes labeling the data, such as by specifying a portion of an image of an exterior wall of a building that corresponds to the glass area and then storing the data by labeling the data values for the specified portion, as illustrated in FIG. 12. In one example, in this step, data augmentation is performed by regenerating 20 images with contrast and contrast adjustments using data augmentation.

Referring to FIG. 11, object detection is performed on the input image, and if the uncertainty result of object detection is higher than the target uncertainty, the object data is increased to learn and extract the detected object data at the same time.

In the case of the present invention, an auto-labeling method was used in this process, so that when an untrained image is entered as an input value to an artificial neural network model, the labeling data obtained can be used for training of the artificial neural network, thereby improving the accuracy of the artificial neural network model and dramatically reducing the work time.

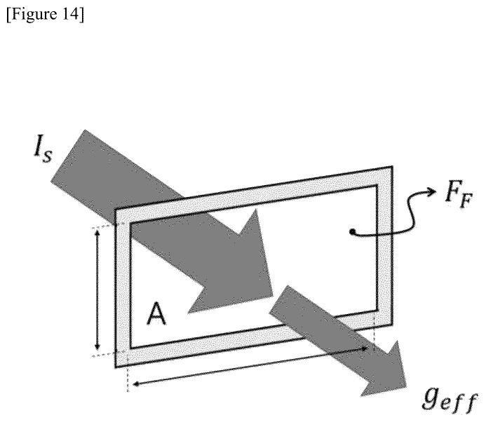

FIG. 13 is a diagram illustrating a method for calculating solar heat gain by window set information calculation device, in accordance with one embodiment of the present invention and FIG. 14 is a graph showing the solar gain by month/year for a window set calculated according to the method shown in FIG. 13.

The optical property information calculator 400 according to one embodiment may calculate the insolation heat gain information based on the output information output by the artificial neural network module calculating window set information 300.

Referring to FIG. 13, the optical property information calculator 400 calculates the window area A based on the window set information output by the artificial neural network module calculating window set information 300, and uses the average monthly insolation (Iₛ), the total effective energy transmittance (Q_{eff}) which includes the characteristics such as whether the window set has a shading device or not and whether the window set is a single window or a double window, the ratio of the glass area in the window (F_{F}) to calculate the heat gain by insolation (Q_{z+tr}) as shown in the Equation (1) below.

Q_{z+tr}=A×Iₛ×Q_{eff}×F_{F} (Equation 1)

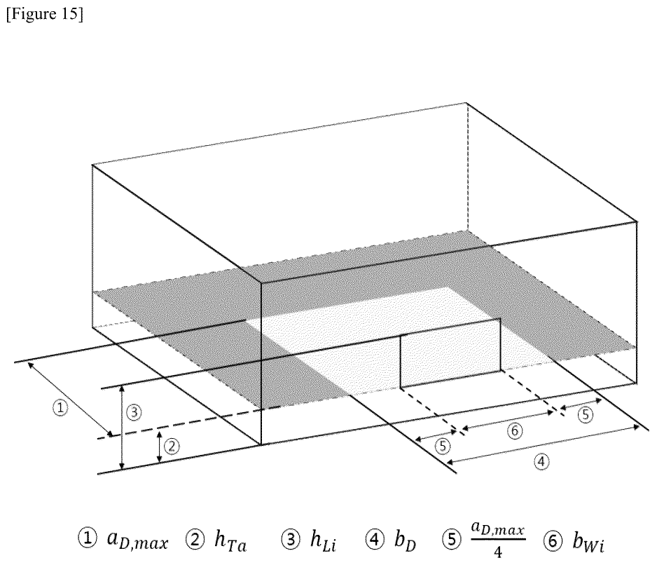

FIG. 15 is a diagram illustrating a method calculating daylight area by window set information calculation device, according to one embodiment of the present invention.

Referring to FIG. 15, the optical property information calculator 400 according to one embodiment derives the maximum depth of the daylight zone from the window longitudinal dimension derived by the artificial neural network module calculating window set information 300. Then, the width of the daylight zone is derived using the derived transverse dimension of the window and the maximum depth of the daylight zone. And the daylight area can be derived by multiplying the width and depth of the daylight zone using Equation 2 below.

a_{D·} [symbol] =2·δ×(h_{Zl}−h_{Ia})[m] (Equation 2)

In Equation 2, a_{D·} [symbol] _{is the maximum depth of the daylight zone, h}_{Zl} is the height to the top of the window, and h_{Ia} is the height to the bottom of the window.

The optical property information calculator 400 can then derive the maximum depth of the daylight zone from Equation 2 and the vertical dimension of the window calculated by the artificial neural network module calculating window set information 300.

$${b}_{D} = b \text{?} + \frac{1}{2} \times a \text{?} [ m ] \qquad ( Equation 3 )$$

$$\text{?} \text{indicates text missing or illegible when filed}$$

In Equation 3, where b^{D} is the width of the daylight zone and b_{Wi} is the width of the window.

Then, the optical property information calculator 400 can derive the width of the daylight zone using Equation 3 and the horizontal dimension of the window calculated by the artificial neural network module calculating window set information 300 and the maximum depth of the derived daylight zone, as shown in Equation 4 below.

A_{D}=a_{D}×b_{D}[m²] (Equation 4)

In Equation 4, where A_{D} is the daylight area and a_{D} is the depth of the daylight zone. The optical property information calculator 400 can derive information about the daylight area through the product of the width and depth of the daylight zone using the above equation 4.

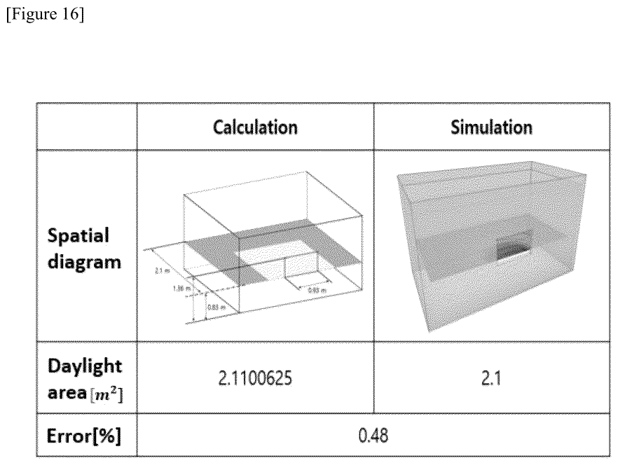

FIG. 16 is a diagram comparing the value for the daylight area derived by window set information calculator according to one embodiment of the present invention with the value derived by the finite element analysis results.

Referring to FIG. 16, the main light area value calculated by the present invention (2.1100625) and the value derived by the finite element analysis (2.1) have an error of only 0.48%, indicating that the accuracy of the present invention is very high.

The foregoing has described in detail a method and device for automatically calculating window set information using an artificial neural network, according to one embodiment.

The method and device for automatically calculating window set information using an artificial neural network according to one embodiment can extract window set shape information of a building in a quick time from a photo image by labeling the shape of a window in a window set image of a building and learning it with an algorithm of an artificial neural network module, and has the advantage of detecting the shape information of a window set and extracting the window set information even when an untrained window set image is input.

Furthermore, the method and device for automatically calculating window set information using an artificial neural network according to one embodiment may be able to auto-label new images and automatically undergo further training to continuously improve accuracy.

Furthermore, the method and device for automatically calculating window set information using an artificial neural network according to one embodiment has the advantage of facilitating deriving information about optical characteristics of the window set, such as solar gain and daylight area of the window set, using the extracted window set information.

The devices described above may be implemented as hardware components, software components, and/or a combination of hardware and software components. For example, the devices and components described in the embodiments may be implemented using one or more general purpose computers or special purpose computers, such as, for example, a processor, controller, arithmetic logic unit (ALU), digital signal processor, microcomputer, field programmable array (FPA), programmable logic unit (PLU), microprocessor, or any other device capable of executing and responding to instructions. The processing device may include an operating system (OS) and one or more software applications executable on the operating system. The processing device may also access, store, manipulate, process, and generate information in response to the execution of the software. For ease of understanding, a processing device is sometimes described as utilizing a single processing element, but one of the ordinary skills in the art will recognize that a processing device may include a plurality of processing elements and/or a plurality of types of processing elements. For example, a processing device may include a plurality of processors or one processor and one controller. Other processing configurations are also possible, such as parallel processors.

Software may include computer programs, code, instructions, or one or more combinations thereof, and may configure a processing device to operate as desired or may independently or collectively instruct a processing device. The software and/or information may be embodied in any type of machine, component, physical device, virtual equipment, computer storage medium, or device, for interpretation by a processing device or for providing instructions or information to a processing device. Software may also be distributed on networked computer systems and stored or executed in a distributed manner. The software and information may be stored on one or more computer-readable recording media.

The methods according to embodiments may be implemented in the form of program instructions that may be executed through various computer means and recorded on a computer-readable medium. Examples of computer-readable recording media include magnetic media, such as hard disks, floppy disks, and magnetic tape; optical media, such as CD-ROMs and DVDs; magneto-optical media, such as floptical disks; and hardware devices specifically configured to store and execute program instructions, such as ROMs, RAMS, flash memory, and the like. Examples of program instructions include machine language code, such as that created by a compiler, as well as high-level language code that can be executed by a computer using an interpreter or the like.

Although embodiments have been described above by way of limited examples and drawings, various modifications and variations from the above description are possible to those of ordinary skill in the art. For example, the described techniques may be performed in a different order than described, and/or components of the described systems, structures, devices, circuits, etc. may be combined or combined in a different form than described, or substituted or replaced by other components or equivalents, and still achieve suitable results. Therefore, other implementations, other embodiments, and equivalents of the claims are also within the scope of the following patent claims.

1. A device for automatically calculating window set information using artificial neural networks comprising:
a pre-trained artificial neural network module calculating window set information having a first input information comprising image information as input information, and a window set information extracting window set characteristics from the image information as output information; and
a feature extractor for extracting a 1-1 feature map and a 1-2 feature map having different scale values for the image information, in the artificial neural network module calculating window set information,
wherein the artificial neural network module calculating window set information is generating a 3-1 feature map and a 3-2 feature map by applying convolution to the 1-1 feature map and the 1-2 feature map, respectively, and then determining one of the 3-1 feature map and the 3-2 feature map as a final feature map based on a preset criteria, and then calculating the window set information based on the selected final feature map.

2. The device for automatically calculating window set information using artificial neural networks according to claim 1,
wherein the artificial neural network module calculating window set information is calculating confidence information for the 3-1 feature map and the 3-2 feature map and then determining the feature map having a higher confidence value as the final feature map according to the preset criteria.

3. The device for automatically calculating window set information using artificial neural networks according to claim 1,
wherein the artificial neural network module calculating window set information includes a first pre-trained artificial neural network that takes the first input information as input information and outputs the 1-1 feature map corresponding to the image information as output information.

4. The device for automatically calculating window set information using artificial neural networks according to claim 3,
wherein the feature extractor is extracting the 1-2 feature map having a different scale value with the scale value of the 1-1 feature map from the first pre-trained artificial neural network.

5. The device for automatically calculating window set information using artificial neural networks according to claim 4,
wherein the artificial neural network module calculating window set information includes a second pre-trained artificial neural network that takes the 1-1 feature map as input information and the 1-2 feature map as intermediate input information, and outputs a 2-1 feature map corresponding to the 1-1 feature map and a 2-2 feature map corresponding to the 1-2 feature map as output information.

6. The device for automatically calculating window set information using artificial neural networks according to claim 5,
wherein the artificial neural network module calculating window set information includes a third pre-trained artificial neural network that takes the 2-1 feature map and the 2-2 feature map as input information and outputs a 3-2 feature map corresponding to the 2-2 feature map and a 3-1 feature map corresponding to the 2-1 feature map as output information.

7. The device for automatically calculating window set information using artificial neural networks according to claim 6,
wherein the artificial neural network module calculating window set information further includes an FC-layer determining one of the 3-1 feature map and the 3-2 feature map as the final feature map based on preset criteria.

8. The device for automatically calculating window set information using artificial neural networks according to claim 6, further comprising:
an optical property information calculator calculating window set information including area information and length information of windows corresponding to the image information and area information and length information of frame based on the final feature map.

9. The device for automatically calculating window set information using artificial neural networks according to claim 8,
wherein the optical property information calculator calculates solar gain and daylight area based on the window set information.

10. The device for automatically calculating window set information using artificial neural networks according to claim 1,
wherein the feature extractor extracts a 1-3 feature map having different scale values with the 1-1 feature map and the 1-2 feature map about said image information from the artificial neural network module calculating window set information.

11. The device for automatically calculating window set information using artificial neural networks according to claim 10,
wherein the artificial neural network module calculating window set information
is calculating confidence information for the 3-1 feature map and the 3-2 feature map and then determining the feature map having a higher confidence value as the final feature map based on the preset criteria.

12. A method for automatically calculating window set information using artificial neural networks comprising:
a first feature map generating step of taking a first input information including image information as input information and outputting a 1-1 feature map corresponding to the image information as output information using a pre-trained first artificial neural network, a feature extracting step of extracting a 1-1 feature map and a 1-2 feature map having different scale values for the image information by the first artificial neural network;
a third feature map generating step of generating a 3-1 feature map and a 3-2 feature map by applying convolution respectively to the 1-1 feature map and the 1-2 feature map; and
a window set information calculating step of determining one of the 3-1 feature map and the 3-2 feature map as a final feature map based on a preset criteria and then calculating window set information based on the selected final feature map.

13. The method for automatically calculating window set information using artificial neural networks according to claim 12, further comprising:
a window set information calculating step of calculating window set information including area information and length information of windows corresponding to the image information and area information and length information of frame based on the final feature map.

14. A device for automatically calculating window set information using artificial neural networks comprising:
a pre-trained artificial neural network module calculating window set information having a first input information comprising image information as input information, and a window set information extracting window set characteristics from the image information as output information; and
a feature extractor for extracting a 1-1 feature map and a 1-2 feature map having different scale values for the image information, in the artificial neural network module calculating window set information,
wherein the artificial neural network module calculating window set information is generating a 3-1 feature map and a 3-2 feature map by applying convolution to the 1-1 feature map and the 1-2 feature map, respectively, and then determining one of the 3-1 feature map and the 3-2 feature map as a final feature map based on a preset criteria, and then calculating the window set information based on the selected final feature map, and
wherein the artificial neural network module calculating window set information is performing training using a labeling information labeled for the window set information included in the image information.

15. The device for automatically calculating window set information using artificial neural networks according to claim 14,
wherein the artificial neural network module calculating window set information is performing training by using a second input information including the labeling information and the first input information together as input information.
